(19) United States
(12) Patent Application Publication
(10) Pub. No.: US 2005/0131713 A1
(43) Pub. Date: Jun. 16, 2005

(54) METHOD OF INVESTING REAL ESTATE DOWN PAYMENTS

(76) Inventor: W. Scott Hammond, Palm Beach, FL (US)

Correspondence Address: MALIN HALEY AND DIMAGGIO, PA, 1936 S ANDREWS AVENUE, FORT LAUDERDALE, FL, 33316, US

(21) Appl. No.: 10/707,431

(22) Filed: Dec. 12, 2003

(51) Int. Cl. G06F 17/60

(52) U.S. Cl. 705/1

(57) ABSTRACT

The method in which in a real estate transaction with a real estate buyer and a lender, the initial down payment made by the real estate buyer is used to generate earnings. Typically, this is provided by having the lender generate earnings from the down payment received from the buyer through compounding balloon loans. The down payment from the buyer is used as security against the mortgage on behalf of the lender. Using the present invention, both the lender and the buyer have the potential of making additional earnings by using the cash down payment provided by the buyer as a source for generating earnings for the benefit of all the parties.

### BACKGROUND OF INVENTION

1. Field of the Invention

This invention relates to a method of doing business that productively utilizes a real estate down payment with respect to a mortgage on real property that allows for a secured reinvestment of the down payment to generate earnings.

2. Description of Related Art

In a typical real estate transaction, the buyer financing a real estate purchase must provide conventionally a 20% cash down payment to the lender or mortgagee. The cash down payment provides security to the lender so that if the buyer defaults on the mortgage, there is a sufficient monetary cushion between the selling price of the property and the prospective real estate market that the lender can sell the property at a reasonable price that includes a potential 20% drop in real estate prices to get back the mortgagee's original investment. In essence, the 20% cash down payment is additional cash security to the lender that provides payment in full to the seller. In today's real estate market financing, the cash security down payment does not generate earnings. The 20% cash down payment is strictly for security purposes and does not result in additional return on the total money invested either from the lender's point of view or the real estate buyer/borrower.

The present invention allows for a utilization of the cash down payment (typically 20%) required by the lender to generate earnings that could be obtained through compounding balloon loans while still being security to the lender. The down payment is used as equity on behalf of the buyer/borrower. The inventor calls this process quantum economics.

### SUMMARY OF INVENTION

A method of doing business to obtain financial benefit from the down payment used to purchase real estate. The method includes having a seller that sells a real estate parcel to a buyer. The method provides that the initial down payment made by a real estate buyer generates earnings. The buyer pays the lender a 20% cash down payment. Using the method of the present invention, the down payment could generate earnings through compounding balloon loans while still acting as security against the mortgage on behalf of the lender. The lender provides a 100% mortgage and the mortgage payments return the principal.

The down payment provided by the buyer of the real estate is used as equity on behalf of the buyer. The buyer receives the equivalent of an 80% mortgage plus interest with the 20% down payment. In one aspect of the method, the down payment can be considered prepaid interest on the mortgage. In the overall prospective, the down payment earnings are used to increase the lender profits while lowering the buyer/borrower interest rate and/or monthly payments.

Initially, the buyer provides a cash down payment (usually 20%) which is received by the lender. The down payment is used to generate earnings. The earnings can be achieved by compounding interest on balloon loans that is compounded repeatedly by lending the money such as with three year terms so that the down payment can be lent to compound three times every ten years. The down payment cash provided by the buyer is also held as security for the lender and used to generate earnings for the lender. Because the lender holds the down payment cash, the lender can provide a 100% mortgage to pay the seller.

The buyer provides the lender with the down payment money for mortgage security to lower the interest rate while the down payment money is returned to the buyer through equity in the mortgage that can be assumed, transferred or liquidated. The mortgage payments on an 80% mortgage with interest is the same or higher than the monthly payments on a 100% mortgage without interest. For this reason, it does not matter whether the mortgage as seen as an 80% mortgage with interest or 100% mortgage without interest.

The lender using the down payment as security and prepaid interest provides a 100% mortgage without additional interest. The lender having prepaid interest that can be loaned and/or reinvested over the term of the mortgage provides a lower interest mortgage because the lender has greater security with the potential to have significantly higher earnings through the use of the down payment cash.

Because the mortgage is assumable at below market rates, this makes the mortgage holder's property more valuable when selling and has the potential of higher equity return, or the mortgage is transferable which eliminates the cost and time spent on mortgage placement. These options give the borrower liquidity without prepayment penalties.

As an example, a mortgage provided to the buyer would be at a mortgage interest rate at 4.9% interest on a ten year mortgage. This demonstrates that an 80% mortgage at 4.9% has the same monthly payment as 100% mortgage with no interest. The 4.9% interest rate and the ten year term are only used as an example, therefore, higher interest rates and longer terms can and will be used within the scope this invention.

The mortgage interest is fixed at a rate that returns the money lent with the possibility of some profit but profit from the mortgage have already been realized so a variable interest rate that increases interest to match the market is not required.

As an alternate embodiment, the mortgage as provided with the present invention can be insured by placing a 1% on all the mortgages provided in an insurance account that is funded from down payment money. This money is used to cover any late payments or mortgage default costs. By protecting the lender from these losses, it allows the lender to use the balance of the down payment to generate earnings.

It is an object of this invention to provide a business method in which the initial down payment made by a real estate buyer is used to generate earnings.

It is another object of this invention to generate earnings from the down payment received by a lender for a real estate transaction with earnings through compounding balloon loans, in which the down payment is used as security against the mortgage on behalf of the lender.

But yet still another object of this invention is to provide a new method of business wherein the down payment used in a real estate transaction can generate significant earnings that is beneficial to the lender and to the real estate buyer.

### DETAILED DESCRIPTION

A method of doing business in which the down payment provided by a buyer of real estate is utilized by a lender to generate earnings. The method includes the steps that the down payment money for the real estate submitted by the buyer as part of a mortgage transaction is received by the lender and then the lender loans the down payment money to generate earnings. In one example, the earnings come from compounding interest in balloon loans that are compounded repeatedly by lending the money with three year terms so that the money can be lent to compound three times every ten years.

The down payment cash is held as security for the lender while being used to generate earnings for the lender. Because the lender holds the down payment cash, the lender provides a 100% mortgage to pay the seller for the price of the real estate property.

The purchaser or buyer of the real estate is also the borrower that provides the lender with the down payment money for mortgage security in order to lower the interest rate. The down payment money is returned to the borrower through equity in the mortgage that can be assumed, transferred or liquidated.

In a typical conventional real estate loan or mortgage, the buyer must provide a down payment of approximately 20% of the loan or mortgage value. The mortgage payment on an 80% mortgage (20% down payment) with interest is the same or higher than the monthly payments on a 100% mortgage without interest; for this reason, it does not matter whether the mortgage is seen as an 80% mortgage with interest or 100% mortgage without interest.

The lender that uses the down payment of the buyer (20%) as security and prepaid interest provides a 100% mortgage without additional interest. The lender having prepaid interest that can be loaned and/or reinvested over the term of the mortgage provides a lower interest mortgage because the lender has greater security with the potential to have significantly higher earnings.

With respect to the property value that is being mortgaged, the mortgage being assumable at below market rates makes the mortgage holder's property more valuable when selling, thus providing the potential of a higher equity return, or if the mortgage is transferable which practically eliminates the cost and time spent on the mortgage placement. These options provide the buyer with liquidity without prepayment penalties.

In order to provide an example, we will say that the mortgage interest would be 4.9% interest on a ten year mortgage. This is used to demonstrate that an 80% mortgage at 4.9% interest has the same money payments as a 100% mortgage with no interest. The interest at 4.9% and the ten year term on an 80% mortgage are used only as an example. Higher interest and lower terms can be and will be used within the scope of this invention.

The mortgage interest is fixed at a rate that returns the money that has been loaned with the possibility of some profit, but profit from the mortgage has already been realized so a variable interest rate that increases interest to match the market is not needed.

In an alternative embodiment, the mortgage is provided within the scope of this invention can be insured by placing 1% of all mortgages provided in an insurance account that is funded from down payment money. This money is used to cover any late payments or mortgage default costs. By protecting the lender from these losses, the lender can use the balance of the down payment to generate earnings.

In summary, the present invention provides a unique and novel method involved with real estate loans and mortgages in which the parties can generate earnings based on the down payment of cash made by the buyer to the lender for the benefit of all of the parties involved. Heretofore, the down payment has been not utilized to provide potential earnings for the benefit of either the lender or the buyer and borrower. Using the present invention a new dynamic in the real estate mortgage process can be added that increases earnings for the benefit of all parties.

In accordance with these and other objects which will become apparent hereinafter, the instant invention will now be described with particular reference to the accompanying drawings.

1. A method useful in real estate mortgages in which the initial cash payment made by a real estate buyer termed the down payment is used throughout the term of the mortgage to generate earnings.

2. The method as in claim 1 in which the down payment generates earnings through compounding balloon loans.

3. The method as in claim 1 in which the buyer/borrower's down payment is used as security against the mortgage on behalf of the lender.

4. The method as in claim 1 in which the lender provides a 100% mortgage wherein the mortgage payments return the principal.

5. The method as in claim 1 in which the down payment of the buyer/borrower is used as equity on behalf of the buyer.

6. The method as in claim 1 in which the buyer/borrower received the equivalent of an 80% mortgage plus interest with a 20% down payment.

7. The method of claim 1 in which the down payment is considered prepaid interest on the mortgage.

8. The method of claim 1 in which the down payment earnings are used to increase lender profits while lowering borrower interest rates and/or monthly payment.

9. The method as in claim 1 in which the mortgage is assumable or transferable.

10. The method as in claim 1 in which a 4.9% interest, ten year mortgage is derived.

11. The method as in claim 1 in which prepayment penalties are eliminated.

12. The method as in claim 1 in which the mortgage interest rate is fixed through the term of the loan.

13. The method of claim 1 in which the mortgage is insured through a mortgage insurance account.
